(19) United States
(12) Patent Application Publication
(10) Pub. No.: US 2021/0373592 A1
(43) Pub. Date: Dec. 2, 2021

(54) Optical Module With Conformable Portion

(71) Applicant: Ivan S. Maric, Sunnyvale, CA (US)

(72) Inventor: Ivan S. Maric, Sunnyvale, CA (US)

(21) Appl. No.: 16/888,192

(22) Filed: May 29, 2020

(51) Int. Cl. G06F 1/16

(52) U.S. Cl. CPC G06F 1/163

(57) ABSTRACT

A head-mounted device to be worn on a head of a user includes a device housing, a support structure, and an optical module. The optical module includes an optical module housing. The optical module also includes a display that is located at an inner end of the optical module housing and a lens assembly that is located at an outer end of the optical module housing. The optical module also includes a conformable portion that is located at the outer end of the optical module housing, is located adjacent to the lens assembly, extends at least partially around a periphery of the lens assembly, and is engageable with a face portion of the user.

### CROSS-REFERENCE TO RELATED APPLICATIONS

This application claims the benefit of U.S. Provisional Application No. 62/869,710, filed on Jul. 2, 2019, the content of which is hereby incorporated by reference in its entirety for all purposes.

### FIELD

The present disclosure relates generally to the field of head-mounted devices.

### BACKGROUND

Head-mounted devices may be used to show computer-generated reality content to users. These devices may include a housing and a face seal that is designed to be positioned in contact with a user's face.

### SUMMARY

One aspect of the disclosure is a head-mounted device to be worn on a head of a user. The head-mounted device includes a device housing, a support structure, and an optical module. The device housing includes a peripheral wall, an intermediate wall that is bounded by the peripheral wall, an eye chamber on a first side of the peripheral wall, a component chamber on a second side of the peripheral wall, and a face seal. The support structure is connected to the device housing and is configured to secure the device housing with respect to the head of the user. The optical module includes an optical module housing that is connected to the device housing and extends through an opening in the intermediate wall of the device housing, has an inner end that is located in the component chamber, has an outer end that is located in the eye chamber, and defines an interior space that extends between the inner end and the outer end. The optical module also includes a display that is located at the inner end of the optical module housing, and a lens assembly that is located at the outer end of the optical module housing. The optical module also includes a conformable portion that is located at the outer end of the optical module housing, is located adjacent to the lens assembly, extends at least partially around a periphery of the lens assembly, and is engageable with a face portion of the user.

Another aspect of the disclosure is a head-mounted device that includes a device housing and an optical module housing. The optical module is connected to the device housing. The optical module includes a lens assembly and a conformable portion. The lens assembly is configured to be positioned adjacent to an eye of a user and the conformable portion is engageable with a face portion of the user.

Another aspect of the disclosure is optical module that includes an optical module housing that has a first end, a second end, and an interior space that extends from the first end to the second end. The optical module also includes a display that is connected to the first end of the optical module housing and a lens assembly that is connected to the second end of the optical module. The optical module also includes a conformable portion at the second end of the optical module housing, wherein the conformable portion is configured to deform in response to engagement.

Another aspect of the disclosure is optical module that includes an optical module housing that has a first end, a second end, and an interior space that extends from the first end to the second end. The optical module also includes a display that is connected to the first end of the optical module housing and a lens assembly that is connected to the second end of the optical module. The optical module also includes a conformable portion at the second end of the optical module housing, wherein the conformable portion includes a cover portion that defines an enclosed interior space and a fluid in the enclosed interior space.

### BRIEF DESCRIPTION OF THE DRAWINGS

FIG. 1 is a top view illustration that shows a head-mounted device that includes a housing and a support structure.

FIG. 2 is a rear view illustration taken along line A-A of FIG. 1 that shows the housing of the head-mounted device.

FIG. 3 is a cross-section view taken along line B-B of FIG. 1 that shows the housing of the head-mounted device.

FIG. 4 is a perspective view illustration that shows a first example of a conformable portion of the optical module.

FIG. 5 is a perspective view illustration that shows a second example of a conformable portion of the optical module.

FIG. 6 is a cross-section view taken along line A-A of FIG. 1 that shows the optical module and a conformable portion according to a first implementation in an uncompressed position.

FIG. 7 is a cross-section view taken along line A-A of FIG. 1 that shows the optical module and the conformable portion according to the first implementation in a compressed position.

FIG. 8 is a cross-section view taken along line A-A of FIG. 1 that shows the optical module and a conformable portion according to a second implementation in an uncompressed position.

FIG. 9 is a cross-section view taken along line A-A of FIG. 1 that shows the optical module and the conformable portion according to the second implementation in a compressed position.

FIG. 10 is a cross-section view taken along line A-A of FIG. 1 that shows the optical module and a conformable portion according to a third implementation in an uncompressed position.

FIG. 11 is a cross-section view taken along line A-A of FIG. 1 that shows the optical module and the conformable portion according to the third implementation in a compressed position.

FIG. 12 is a cross-section view taken along line A-A of FIG. 1 that shows the optical module and a conformable portion according to a fourth implementation in an uncompressed position.

FIG. 13 is a cross-section view taken along line A-A of FIG. 1 that shows the optical module and the conformable portion according to the fourth implementation in a compressed position.

FIG. 14 is a cross-section view taken along line A-A of FIG. 1 that shows the optical module and a conformable portion according to a fifth implementation in an uncompressed position.

FIG. 15 is a cross-section view taken along line A-A of FIG. 1 that shows the optical module and the conformable portion according to the fifth implementation in a compressed position.

FIG. 16 is a cross-section view taken along line A-A of FIG. 1 that shows the optical module and a conformable portion according to a sixth implementation in an uncompressed position.

FIG. 17 is a cross-section view taken along line A-A of FIG. 1 that shows the optical module and the conformable portion according to the sixth implementation in a compressed position.

FIG. 18 is a cross-section view taken along line A-A of FIG. 1 that shows the optical module and a conformable portion according to a seventh implementation in an uncompressed position.

FIG. 19 is a cross-section view taken along line A-A of FIG. 1 that shows the optical module and the conformable portion according to the seventh implementation in a compressed position.

FIG. 20 is a block diagram that shows an example of a hardware configuration that can be incorporated in the head-mounted device.

### DETAILED DESCRIPTION

The disclosure herein relates to head-mounted devices that used to show computer-generated reality (CGR) content to users and which incorporate design features that accommodate users that have a wide variety of face shapes. The devices described herein position lens assemblies in close proximity to the user's eyes. Support structures extend around the lens assemblies to hold them in a desired position and protect the lens assemblies from damage. The support structures incorporate a conformable portion that deforms upon contact with the user's face in order to increase user comfort and accommodate users having varied facial shapes.

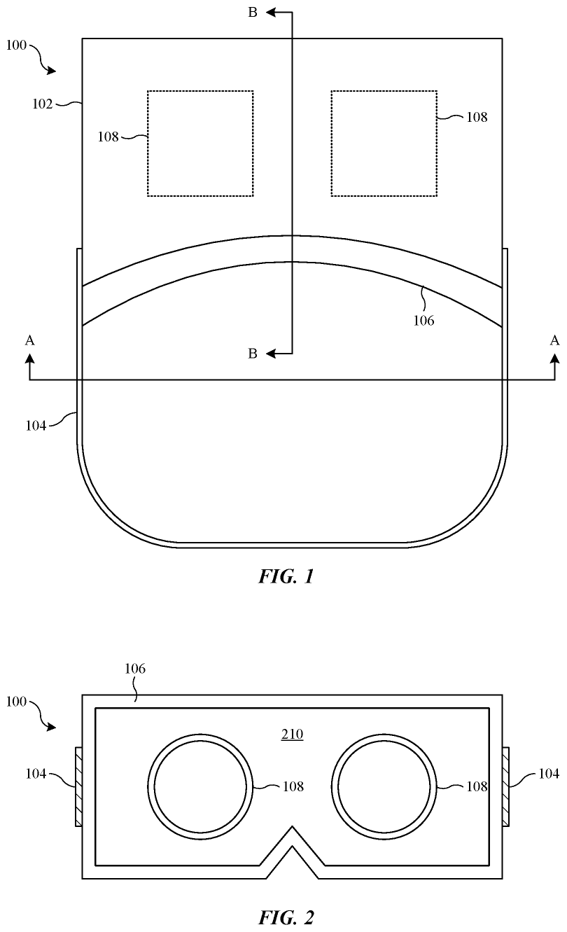

FIG. 1 is a top view illustration that shows a head-mounted device 100. The head-mounted device 100 is intended to be worn on a head of a user and includes components that are configured to display content to the user. Components that are included in the head-mounted device 100 may be configured to track motion of parts of the user's body, such as the user's head and hands. Motion tracking information that is obtained by components of the head-mounted device can be utilized as inputs that control aspects of the generation and display of the content to the user, so that the content displayed to the user can be part of a CGR experience in which the user is able to view and interact with virtual environments and virtual objects. The head-mounted device 100 includes a device housing 102, a support structure 104, a face seal 106, and optical modules 108.

The device housing 102 is a structure that supports various other components that are included in the head-mounted device. The device housing 102 may be an enclosed structure such that certain components of the head-mounted device 100 are contained within the device housing 102 and thereby protected from damage. The support structure 104 is connected to the device housing 102. The support structure 104 is a component or collection of components that function to secure the device housing 102 in place with respect to the user's head so that the device housing 102 is restrained from moving with respect to the user's head and maintains a comfortable position during use. The support structure 104 can be implemented using rigid structures, elastic flexible straps, or inelastic flexible straps. Although not illustrated, the support structure 104 may include passive or active adjustment components, which may be mechanical or electromechanical. In the illustrated example, the support structure 104 is a headband type device that is connected to left and right lateral sides of the device housing 102 and is intended to extend around the user's head. Other configurations may be used for the support structure 104, such as a halo-type configuration in which the device housing 102 is supported by a structure that is connected to a top portion of the device housing 102, engages the user's forehead above the device housing 102, and extends around the user's head, or a mohawk-type configuration in which a structure extends over the user's head.

The face seal 106 is connected to the device housing 102 and is located at areas around a periphery of the device housing 102 where contact with the user's face is likely. The face seal 106 functions to conform to portions of the user's face to allow the support structure 104 to be tensioned to an extent that will restrain motion of the device housing 102 with respect to the user's head. The face seal 106 may also function to reduce the amount of light from the physical environment around the user that reaches the user's eyes. The face seal 106 may contact areas of the user's face, such as the user's forehead, temples, and cheeks. The face seal 106 may be formed from a compressible material, such as open-cell foam or closed cell foam.

The optical modules 108 are each assemblies that include multiple components. The components that are included in the optical modules support the function of displaying content to the user in a manner that supports CGR experiences. Two of the optical modules 108 are shown in the illustrated example, including a left-side optical module that is configured to display content to a user's left eye and a right-side optical module that is configured to display content to a user's right eye in a manner that supports stereo vision. Components that may be included in each of the optical modules 108 include an optical module housing that supports and contains components of the optical module 108, a display screen (which may be a common display screen shared by the optical modules 108 or a separate display screen), and a lens assembly that includes one or more lenses to direct light from the display screen to the user's eye. Other components may also be included in each of the optical modules. Although not illustrated in FIG. 1, the optical modules may be supported by adjustment assemblies that allow the position of the optical modules 108 to be adjusted. As an example, the optical modules 108 may each be supported by an interpupillary distance adjustment mechanism that allows the optical modules 108 to slide laterally toward or away from each other. As another example, the optical modules 108 may be supported by an eye relief distance adjustment mechanism that allows adjustment of the distance between the optical modules 108 and the user's eyes.

FIG. 2 is a rear view illustration taken along line A-A of FIG. 1 that shows the device housing 102 of the head-mounted device 100 and an eye chamber 210 that is defined by the device housing 102 of the head-mounted device 100. The eye chamber 210 is a space that is defined by the device housing 102 and is open to the exterior of the head-mounted device 100. In a simple example, the eye chamber could be a roughly rectangular area that is bounded by portions of the device housing 102 on five sides and is open on one side where the user's face will be positioned when the head-mounted device 100 is worn by the user. When the head-mounted device 100 is worn by the user, the eye chamber 210 is positioned adjacent to the face of the user and is substantially isolated from the surrounding exterior environment by the face seal 106, as portions of the device housing 102 and the face seal 106 extend around the periphery of the eye chamber 210. Portions of the optical modules 108 are located in the eye chamber 210, so that the user can see the content that is displayed by the optical modules 108. The optical modules 108 are located within the eye chamber 210 at locations that are intended to be adjacent to the user's orbital cavities. The face seal 106 is located outward from the optical modules 108 and the face seal is separated from the optical modules 108 by the eye chamber 210.

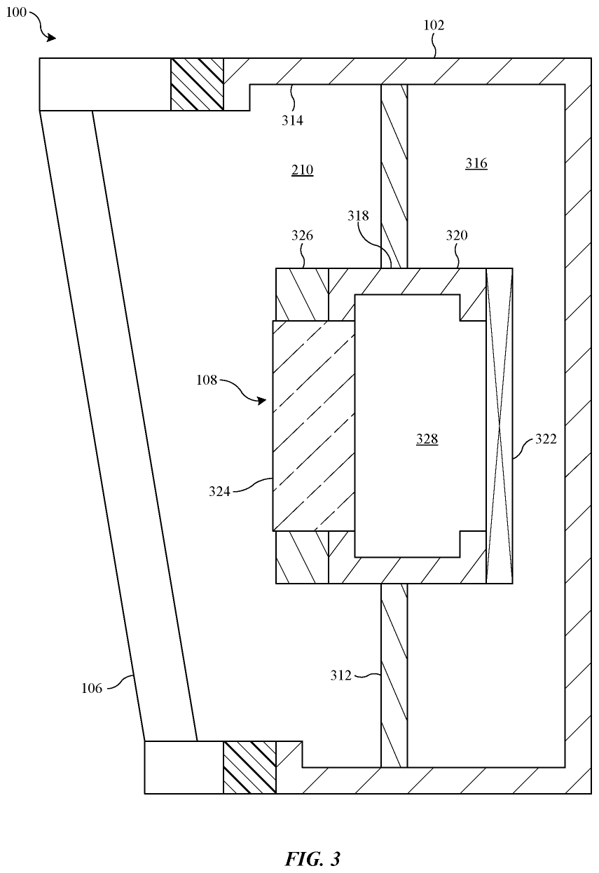

As best seen in FIG. 3, which is a cross-section view taken along line B-B of FIG. 1 that shows the device housing 102 of the head-mounted device 100, the device housing 102 includes an intermediate wall 312 and a peripheral wall 314. The intermediate wall 312 extends laterally across the device housing 102 and is bounded by the peripheral wall 314 of the device housing 102, which defines a top part, bottom part, left side part, and right side part of the device housing 102. The peripheral wall 314 may form top, bottom, left, and or right side surfaces of the device housing 102. The face seal 106 may be connected to the peripheral wall 314. The intermediate wall 312 separates the eye chamber 210 from a component chamber 316, which may be a fully enclosed area of the device housing 102 of the head-mounted device 100. The component chamber 316 is an interior portion of the device housing 102 that contains electrical components of the head-mounted device 100 that are not exposed to the exterior of the device. In the illustrated example, the optical modules 108 are located partly in the eye chamber 210 and partly in the component chamber 316 and extend through openings 318 that are formed through the intermediate wall 312. Thus, the optical modules 108 extend longitudinally outward from the intermediate wall 312, with the longitudinal direction being defined as a direction that extends toward the user relative to the intermediate wall 312 (e.g., generally aligned with respect to the optical axes of the optical modules 108).

The optical module 108 includes an optical module housing 320, a display 322, a lens assembly 324, and a conformable portion 326. Each of the optical module housings 320 is supported with respect to the device housing 102 either in a fixed position by an assembly that allows controlled movement of the optical modules 108, for example, for interpupillary distance adjustment or for eye relief adjustment. The optical module housing 320 provides a structure that supports other components, including the display 322, the lens assembly 324, and the conformable portion 326. The optical module housing 320 also protects the other components of the optical module 108 from mechanical damage, and provides a structure that other components can be sealed against to seal an interior space 328 relative to the exterior to prevent foreign particles (e.g., dust) from entering the interior space 328.

The optical module housing 320 may be a generally cylindrical, tubular structure having wall portions that extend around the interior space 328. Although shown in the illustrated example as a cylinder having a generally circular cross-section along the optical axis of the optical module 108, the optical module housing may instead utilize another shape, such as an oval shape or a rectangular shape. The shape of the optical module housing 320 need not be a regular geometric shape, and may instead be an irregular, compound shape, that incorporates various features and structures that have specific functions. The optical module housing 320 may be formed from a generally rigid and inflexible material, such as plastic or metal.

The interior space 328 of the optical module housing 320 may extend between open ends that are spaced along the optical axis of the optical module 108 (e.g., between a first end of the optical module housing 320 and a second end of the optical module housing 320). For example, an outer open end may be located in the eye chamber 210 and an inner open end may be located in the component chamber 316. The display 322 is located at the inner open end of the optical module housing 320 and the lens assembly 324 is located at the outer open end of the optical module housing 320. This configuration allows light from the display 322 to be projected along the optical axis of the optical module 108 such that the light is incident on the lens assembly 324 and is shaped by the lens assembly 324 in a manner that causes images that are projected by the display 322 to be displayed to each of the user's eyes by the optical modules 108.

The conformable portion 326 of the optical module housing 320 is configured such that it is able to conform to the user's face in the area of the orbital cavity. The conformable portion 326 is flexible and may be elastic to permit deformation and return to a nominal (e.g., uncompressed) shape. Deformation of the conformable portion 326 may occur primarily in the radial or lateral direction relative to the optical axis of the optical modules 108 (e.g., in a direction generally perpendicular to the optical axis), but some degree of compression in the longitudinal direction (e.g., in a direction aligned with the optical axis) will typically be present as well. As will be described further herein, the conformable portion 326 may be a passive structure that deforms in response to application of force without any active control of deformation, or may be an active structure that includes components that control deformation using some manner of controlled actuation.

The conformable portion 326 is located at the outer open end of the optical module housing and is adjacent to the lens assembly 324. The conformable portion 326 may form part or all of an axial end surface of the optical module housing 320 and may form part of the radial surface of the optical module housing 320. The axial end surface of the conformable portion 326 may extend outward (toward the user) relative to the axial end surface of the lens assembly 324, the axial end surface of the conformable portion 326 may be substantially flush with the axial end surface of the lens assembly 324, or the axial end surface of the lens assembly 324 may extend outward (toward the user) relative to the axial end surface of the conformable portion 326.

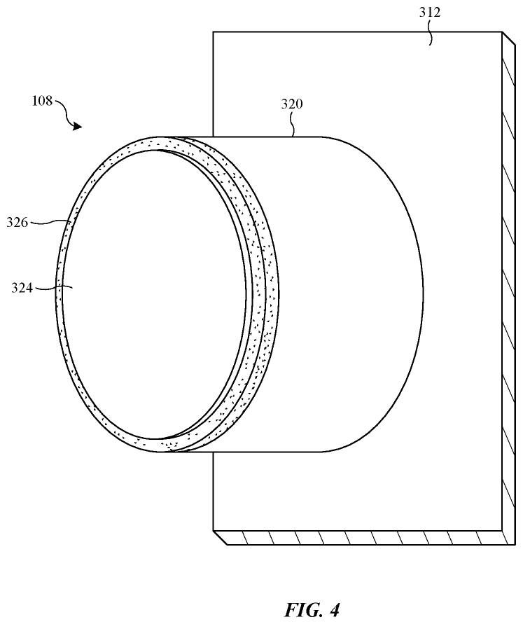

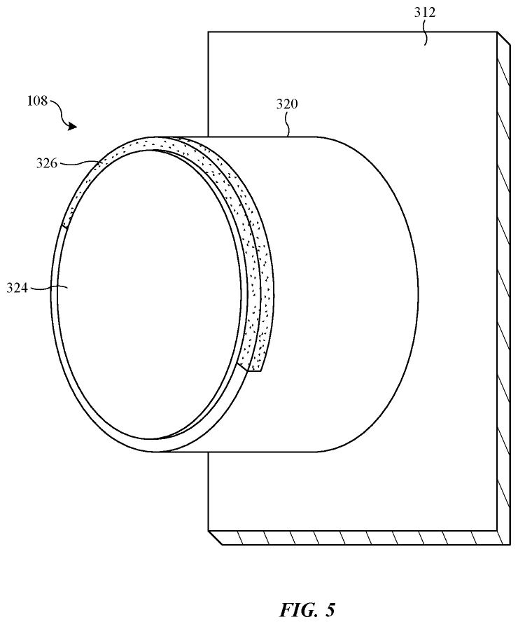

In some implementations, the conformable portion 326 extends continuously around the lens assembly 326 as shown in FIG. 4, which is a perspective view illustration that shows a first example the conformable portion 326 of the optical module 108. In some implementations, the conformable portion 326 extends around a portion of the lens assembly 326 as shown in FIG. 5, which is a perspective view illustration that shows a second example of a conformable portion of the optical module. As one example, the conformable portion 326 may extend half way around the periphery of the lens assembly 324 at the axial end surface of the optical module 108, with rigid portions of the optical module 108 present otherwise. The conformable portions 326 may be located such that they are able to contact the areas above the user's eye and alongside the user's nose. As another example, the conformable portion 326 may include two or more separate conformable portions located at the axial end surface of the optical module 108 with rigid portions of the optical module housing 320 present at other locations of the axial end surface of the optical module 108.

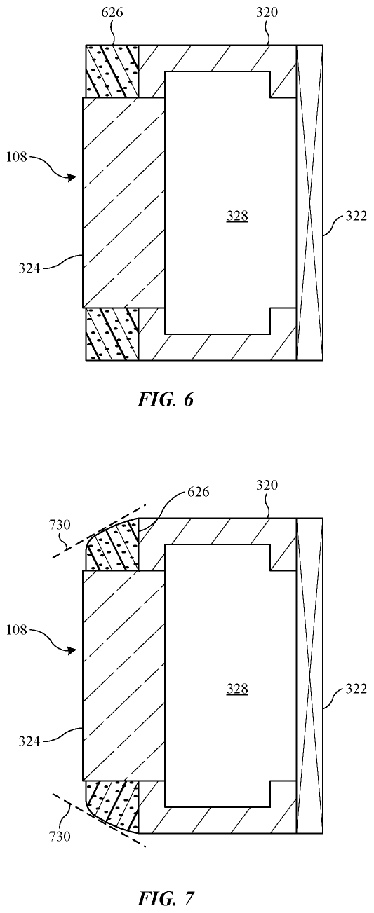

FIG. 6 is a cross-section view taken along line A-A of FIG. 1 that shows the optical module 108 and a conformable portion 626 according to a first implementation in an uncompressed position. FIG. 7 is a cross-section view taken along line A-A of FIG. 1 that shows the optical module 108 and the conformable portion 626 in a compressed position. The conformable portion 626 is formed from an elastic, flexible material that is compliant and readily flexible. As one example, the conformable portion 626 may be formed from open cell foam rubber. As another example, the conformable portion 626 may be formed from closed cell foam rubber. As another example the conformable portion 626 may be formed from silicone rubber (e.g., by over-molding the silicone rubber onto the optical module housing 320 of the optical module 108).

The conformable portion 626 is in the uncompressed position (FIG. 6) when no external force is applied (e.g., the user's face is not engaged with the conformable portion 626). The conformable portion 626 is in the compressed position (FIG. 7) when it is contacted by face portions 730 of the user's face. As an example, the face portions 730 may be areas adjacent to the orbital cavity. The conformable portion 626 may be compressed laterally and/or longitudinally by engagement with the face portions 730 in the compressed position. By engagement of the conformable portion 626 with the face portions 730, potential discomfort is avoided by contact with a conformable and compliant structure as opposed to contact with a rigid structure.

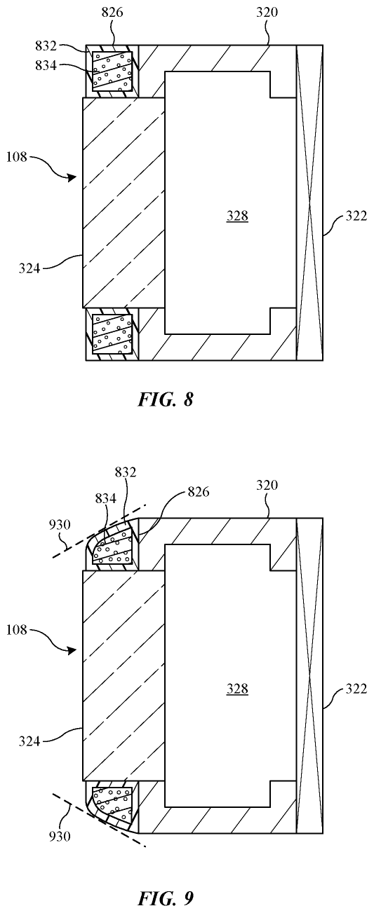

FIG. 8 is a cross-section view taken along line A-A of FIG. 1 that shows the optical module 108 and a conformable portion 826 according to a second implementation in an uncompressed position. FIG. 9 is a cross-section view taken along line A-A of FIG. 1 that shows the optical module 108 and the conformable portion 826 in a compressed position. The conformable portion 826 includes a cover portion 832 that defines an enclosed interior space that contains a flowable viscous material 834. The cover portion 832 is a thin, elastic, flexible, and generally impermeable material that readily yields when engaged. The cover portion 832 contains the flowable viscous material 834 such that the flowable viscous material 834 is able to flow within the cover portion 832 in response to external forces, thereby allowing the conformable portion 826 to take the shape of the objects that contact it. The flowable viscous material 834 may be a liquid or a non-Newtonian fluid that has a relatively high viscosity (e.g., greater than 10,000 pascal-seconds).

The conformable portion 826 is in the uncompressed position (FIG. 8) when no external force is applied (e.g., the user's face is not engaged with the conformable portion 826). The conformable portion 826 is in the compressed position (FIG. 9) when it is contacted by face portions 930 of the user's face. As an example, the face portions 930 may be areas adjacent to the orbital cavity. The conformable portion 826 may be compressed laterally and/or longitudinally by engagement with the face portions 930 in the compressed position. By engagement of the conformable portion 826 with the face portions 930, potential discomfort is avoided by contact with a conformable and compliant structure as opposed to contact with a rigid structure.

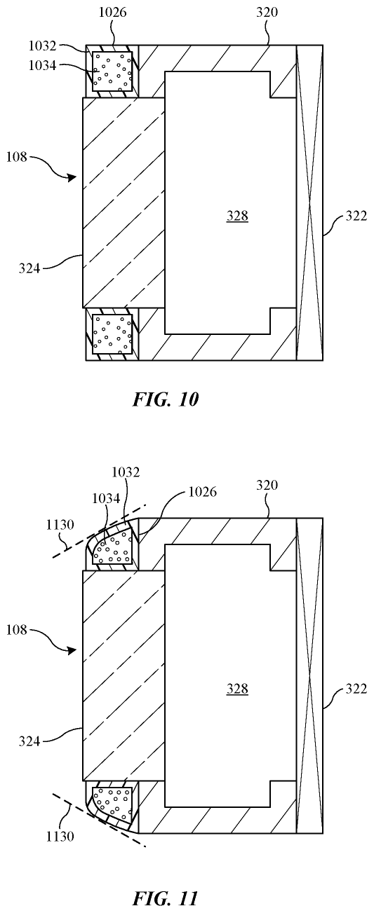

FIG. 10 is a cross-section view taken along line A-A of FIG. 1 that shows the optical module 108 and a conformable portion 1026 according to a third implementation in an uncompressed position. FIG. 11 is a cross-section view taken along line A-A of FIG. 1 that shows the optical module 108 and the conformable portion 1026 in a compressed position. The conformable portion 1026 includes a cover portion 1032 that defines an enclosed interior space that contains a gas 1034. The cover portion 1032 is a thin, elastic, flexible, and generally impermeable material that readily yields when engaged. The cover portion 1032 contains the gas 1034 such that the gas 1034 is able to flow within the cover portion 1032 in response to external forces, thereby allowing the conformable portion 1026 to take the shape of the objects that contact it. The gas 1034 may be any gas, such as air at atmospheric pressure or at greater than atmospheric pressure.

The conformable portion 1026 is in the uncompressed position (FIG. 10) when no external force is applied (e.g., the user's face is not engaged with the conformable portion 1026). The conformable portion 1026 is in the compressed position (FIG. 11) when it is contacted by face portions 1130 of the user's face. As an example, the face portions 1130 may be areas adjacent to the orbital cavity. The conformable portion 1026 may be compressed laterally and/or longitudinally by engagement with the face portions 1130 in the compressed position. By engagement of the conformable portion 1026 with the face portions 1130, potential discomfort is avoided by contact with a conformable and compliant structure as opposed to contact with a rigid structure.

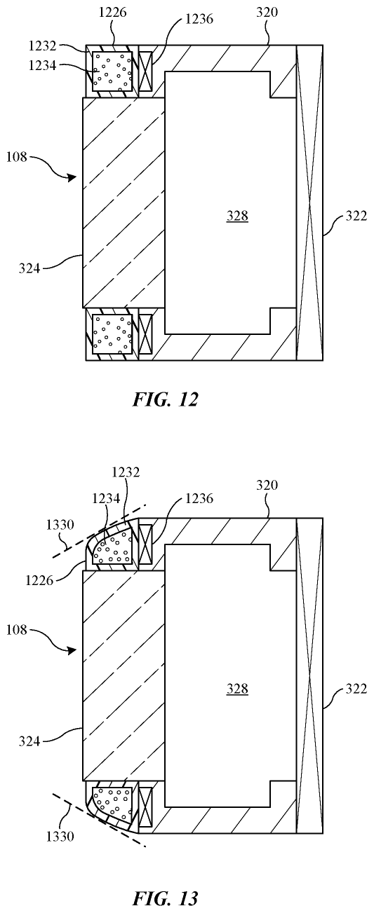

FIG. 12 is a cross-section view taken along line A-A of FIG. 1 that shows the optical module 108 and a conformable portion 1226 according to a fourth implementation in an uncompressed position. FIG. 13 is a cross-section view taken along line A-A of FIG. 1 that shows the optical module 108 and the conformable portion 1226 in a compressed position. The conformable portion 1226 includes a cover portion 1232 that defines an enclosed interior space that contains a magnetorheological (MR) fluid 1234. The conformable portion 1226 also includes an electromagnet 1236. The cover portion 1232 is a thin, elastic, flexible, and generally impermeable material that readily yields when engaged. The cover portion 1232 contains the MR fluid 1234 such that the MR fluid 1234 is able to flow within the cover portion 1232 in response to external forces, thereby allowing the conformable portion 1226 to take the shape of the objects that contact it. The MR fluid 1234 may be any suitable type of MR fluid, which generally include ferromagnetic particles suspended in a liquid, such as oil. The electromagnet 1236 is controllable between an inactive state and an active state. When the electromagnet 1236 is in the inactive state, the MR fluid is able to flow. When the electromagnet 1236 is in the active state, the electromagnet 1236 emits a magnetic flux field. The ferromagnetic particles in the MR fluid align themselves with the magnetic flux field that is emitted by the electromagnet 1236, which causes the MR fluid 1234 to resist flowing, thereby maintaining the shape of the conformable portion 1226.

The conformable portion 1226 is in the uncompressed position (FIG. 12) when no external force is applied (e.g., the user's face is not engaged with the conformable portion 1226). The conformable portion 1226 is in the compressed position (FIG. 13) when it is contacted by face portions 1330 of the user's face. As an example, the face portions 1330 may be areas adjacent to the orbital cavity. The conformable portion 1226 may be compressed laterally and/or longitudinally by engagement with the face portions 1330 in the compressed position. By engagement of the conformable portion 1226 with the face portions 1330, potential discomfort is avoided by contact with a conformable and compliant structure as opposed to contact with a rigid structure. The conformable portion 1226 may be controlled by placing the electromagnet 1236 in the inactive state prior to engagement with the face portions 1330 of the user, and by subsequently placing the electromagnet 1236 in the active state after engagement with the face portions 1330 of the user to maintain the compressed position of the conformable portion 1226 after disengagement of the face portions 1330 of the user from the conformable portion 1226.

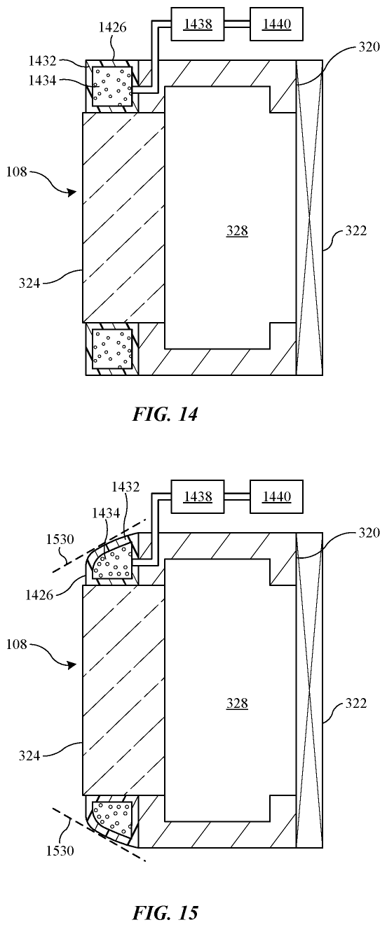

FIG. 14 is a cross-section view taken along line A-A of FIG. 1 that shows the optical module 108 and a conformable portion 1426 according to a fifth implementation in an uncompressed position. FIG. 15 is a cross-section view taken along line A-A of FIG. 1 that shows the optical module 108 and the conformable portion 1426 in a compressed position. The conformable portion 1426 includes a cover portion 1432 that defines an enclosed interior space that contains a fluid 1434. The conformable portion 1426 also includes an actuator 1438 and a fluid source 1440. The cover portion 1432 is a thin, elastic, flexible, and generally impermeable material that readily yields when engaged. The cover portion 1432 contains the fluid 1434 such that the fluid 1434 is able to flow within the cover portion 1432 in response to external forces, thereby allowing the conformable portion 1426 to take the shape of the objects that contact it. The fluid 1434 may be any type of fluid, including liquids and gases. The actuator 1438 is able to cause the fluid 1434 to flow into and out of the interior of the cover portion 1432, with excess volumes of the fluid 1434 being stored in the fluid source 1440, which may be a reservoir or other structure able to store or supply the fluid 1434. The actuator 1438 may be a pump or other device that is controlled to change the volume of the fluid 1434 that is present in the cover portion 1432 in order to expand and contract the volume displaced by the conformable portion 1426.

The conformable portion 1426 is in the uncompressed position (FIG. 14) when no external force is applied (e.g., the user's face is not engaged with the conformable portion 1426). The conformable portion 1426 is in the compressed position (FIG. 15) when it is contacted by face portions 1530 of the user's face. As an example, the face portions 1530 may be areas adjacent to the orbital cavity. The conformable portion 1426 may be compressed laterally and/or longitudinally by engagement with the face portions 1530 in the compressed position. By engagement of the conformable portion 1426 with the face portions 1530, potential discomfort is avoided by contact with a conformable and compliant structure as opposed to contact with a rigid structure. The volume of the conformable portion 1426 may be controlled by adding or removing part of the fluid from the cover portion 1432 using the actuator 1438.

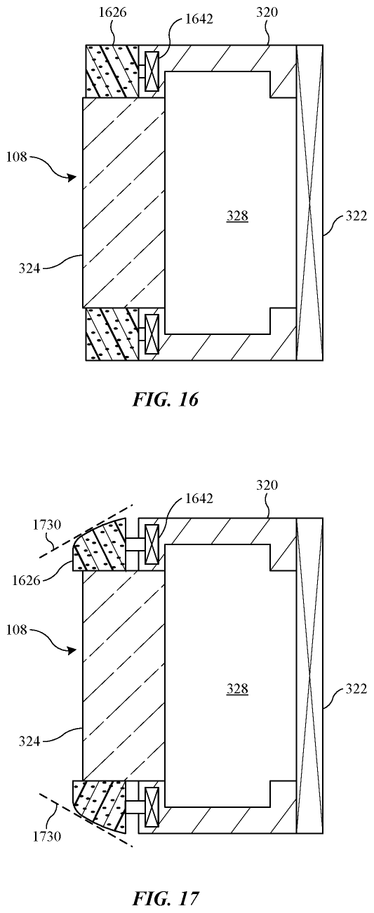

FIG. 16 is a cross-section view taken along line A-A of FIG. 1 that shows the optical module 108 and a conformable portion 1626 according to a sixth implementation in an uncompressed position. FIG. 17 is a cross-section view taken along line A-A of FIG. 1 that shows the optical module 108 and the conformable portion 1626 in a compressed position. The conformable portion 1626 can be implemented using any of the conformable materials previously described including active and passive configurations. An actuator 1642 is configured to move the conformable portion 1626 in a generally longitudinal direction between a retracted position (FIG. 16) and an extended position (FIG. 17) in order to change the distance between the conformable portion 1626 user. The actuator 1642 may be any type of actuator capable of moving the conformable portion 1626, such as an electromechanical linear actuator. One or more actuators may be included.

The conformable portion 1626 is in the uncompressed position (FIG. 16) when no external force is applied (e.g., the user's face is not engaged with the conformable portion 1626). The conformable portion 1626 is in the compressed position (FIG. 17) when it is contacted by face portions 1730 of the user's face. As an example, the face portions 1730 may be areas adjacent to the orbital cavity. The conformable portion 1626 may be compressed laterally and/or longitudinally by engagement with the face portions 1730 in the compressed position. By engagement of the conformable portion 1626 with the face portions 1730, potential discomfort is avoided by contact with a conformable and compliant structure as opposed to contact with a rigid structure. The conformable portion 1626 may be controlled to move it between extended and retracted positions to obtain a comfortable fit for the user.

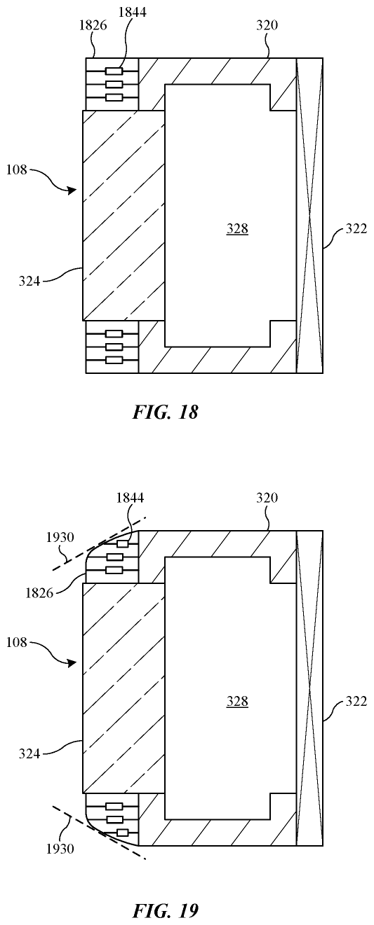

FIG. 18 is a cross-section view taken along line A-A of FIG. 1 that shows the optical module 108 and a conformable portion 1826 according to a seventh implementation in an uncompressed position. FIG. 19 is a cross-section view taken along line A-A of FIG. 1 that shows the optical module 108 and the conformable portion 1826 in a compressed position. The conformable portion 1826 can be implemented using any of the conformable materials previously described including active and passive configurations. Gauges 1844 are configured to measure a property that represents deformation of the conformable portion 1826 and output a corresponding signal. As examples, the property may be strain, pressure, or deflection. Other properties could be measured to represent deformation of the conformable portion 1826. The gauges 1844 output a signal in response to engagement of face portions 1930 of the user's face with the conformable portion 1826. The signal output by the gauges 1844 may be used as a basis for controlling the active features of conformable portions as described previously herein. The signal output by the gauges 1844 may be used to control other aspects of the operation of the head-mounted device 100. As one example, an eye relief adjustment mechanism may be controlled using the signal that is output by the gauges 1844. As another example a controllable headband tensioner may be included in the head-mounted device 100 and the signal that is output by the gauges 1844 may be used to control tension of the support structure 104.

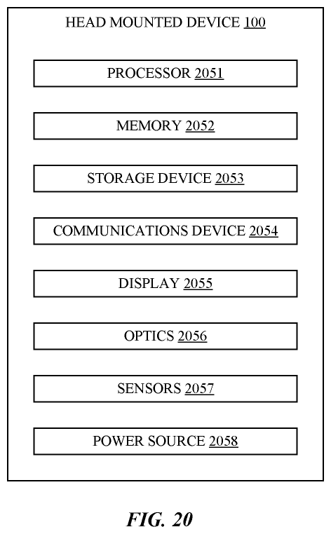

FIG. 20 is a block diagram that shows an example of a hardware configuration that can be incorporated in the head-mounted device 100 to facilitate presentation of CGR content to users. The head-mounted device 100 may include a processor 2051, a memory 2052, a storage device 2053, a communications device 2054, a display 2055, optics 2056, sensors 2057, and a power source 2058.

The processor 2051 is a device that is operable to execute computer program instructions and is operable to perform operations that are described by the computer program instructions. The processor 2051 may be implemented using a conventional device, such as a central processing unit, and provided with computer-executable instructions that cause the processor 2051 to perform specific functions. The processor 2051 may be a special-purpose processor (e.g., an application-specific integrated circuit or a field-programmable gate array) that implements a limited set of functions. The memory 2052 may be a volatile, high-speed, short-term information storage device such as a random-access memory module. The storage device 2053 is intended to allow for long term storage of computer program instructions and other data. Examples of suitable devices for use as the storage device 2053 include non-volatile information storage devices of various types, such as a flash memory module, a hard drive, or a solid-state drive.

The communications device 2054 supports wired or wireless communications with other devices. Any suitable wired or wireless communications protocol may be used.

The display 2055 is a display device that is operable to output images according to signals received from the processor 2051 and/or from external devices using the communications device 2054 in order to output CGR content to the user. As an example, the display 2055 may output still images and/or video images in response to received signals. The display 2055 may include, as examples, an LED screen, an LCD screen, an OLED screen, a micro LED screen, or a micro OLED screen.

The optics 2056 are configured to guide light that is emitted by the display 2055 to the user's eyes to allow content to be presented to the user. The optics 2056 may include lenses or other suitable components. The optics 2056 allow stereoscopic images to be presented to the user in order to display CGR content to the user in a manner that causes the content to appear three-dimensional.

The sensors 2057 are components that are incorporated in the head-mounted device 100 to provide inputs to the processor 2051 for use in generating the CGR content. The sensors 2057 include components that facilitate motion tracking (e.g., head tracking and optionally handheld controller tracking in six degrees of freedom). The sensors 2057 may also include additional sensors that are used by the device to generate and/or enhance the user's experience in any way. The sensors 2057 may include conventional components such as cameras, infrared cameras, infrared emitters, depth cameras, structured-light sensing devices, accelerometers, gyroscopes, and magnetometers. The sensors 2057 may also include biometric sensors that are operable to physical or physiological features of a person, for example, for use in user identification and authorization. Biometric sensors may include fingerprint scanners, retinal scanners, and face scanners (e.g., two-dimensional and three-dimensional scanning components operable to obtain image and/or three-dimensional surface representations). Other types of devices can be incorporated in the sensors 2057. The information that is generated by the sensors 2057 is provided to other components of the head-mounted device 100, such as the processor 2051, as inputs.

The power source 2058 supplies electrical power to components of the head-mounted device 100. In some implementations, the power source 2058 is a wired connection to electrical power. In some implementations, the power source 2058 may include a battery of any suitable type, such as a rechargeable battery. In implementations that include a battery, the head-mounted device 100 may include components that facilitate wired or wireless recharging.

In some implementations of the head-mounted device 100, some or all of these components may be included in a separate device that is removable. For example, any or all of the processor 2051, the memory 2052, and/or the storage device 2053, the communications device 2054, the display 2055, and the sensors 2057 may be incorporated in a device such as a smart phone that is connected to (e.g., by docking) the other portions of the head-mounted device 100.

In some implementations of the head-mounted device 100, the processor 2051, the memory 2052, and/or the storage device 2053 are omitted, and the corresponding functions are performed by an external device that communicates with the head-mounted device 100. In such an implementation, the head-mounted device 100 may include components that support a data transfer connection with the external device using a wired connection or a wireless connection that is established using the communications device 2054.

A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

In contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands).

A person may sense and/or interact with a CGR object using any one of their senses, including sight, sound, touch, taste, and smell. For example, a person may sense and/or interact with audio objects that create three-dimensional or spatial audio environment that provides the perception of point audio sources in three-dimensional space. In another example, audio objects may enable audio transparency, which selectively incorporates ambient sounds from the physical environment with or without computer-generated audio. In some CGR environments, a person may sense and/or interact only with audio objects.

Examples of CGR include virtual reality and mixed reality.

A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end.

In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.

Examples of mixed realities include augmented reality and augmented virtuality.

An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment.

An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

There are many different types of electronic systems that enable a person to sense and/or interact with various CGR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

As described above, one aspect of the present technology is the gathering and use of data available from various sources to adjust the fit and comfort of a head-mounted device. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, a user profile may be established that stores fit and comfort related information that allows the head-mounted device to be actively adjusted for a user. Accordingly, use of such personal information data enhances the user's experience.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of storing a user profile to allow automatic adjustment of a head-mounted device, the present technology can be configured to allow users to select to “opt in” or “opt out” of participation in the collection of personal information data during registration for services or anytime thereafter. In another example, users can select not to provide data regarding usage of specific applications. In yet another example, users can select to limit the length of time that application usage data is maintained or entirely prohibit the development of an application usage profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, fit and comfort related parameters may be determined each time the head-mounted device is used, such as by scanning a user's face as they place the device on their head, and without subsequently storing the information or associating with the particular user.

What is claimed is:

1. A head-mounted device to be worn on a head of a user, comprising:
a device housing that includes a peripheral wall, an intermediate wall that is bounded by the peripheral wall, an eye chamber on a first side of the peripheral wall, a component chamber on a second side of the peripheral wall, and a face seal;
a support structure that is connected to the device housing and is configured to secure the device housing with respect to the head of the user; and
an optical module that includes:
an optical module housing that is connected to the device housing and extends through an opening in the intermediate wall of the device housing, has an inner end that is located in the component chamber, has an outer end that is located in the eye chamber, and defines an interior space that extends between the inner end and the outer end,
a display that is located at the inner end of the optical module housing,
a lens assembly that is located at the outer end of the optical module housing,
a conformable portion that is located at the outer end of the optical module housing, is located adjacent to the lens assembly, extends at least partially around a periphery of the lens assembly, and is engageable with a face portion of the user.

2. The head-mounted device of claim 1, wherein the conformable portion is formed from a resilient flexible material.

3. The head-mounted device of claim 1, wherein the conformable portion is formed from a foam rubber material.

4. The head-mounted device of claim 1, wherein the conformable portion is formed from a silicone rubber material.

5. The head-mounted device of claim 1, wherein the conformable portion includes a cover portion that defines an enclosed interior space and a fluid in the enclosed interior space.

6. The head-mounted device of claim 1, further comprising an actuator that is operable to move the conformable portion.

7. The head-mounted device of claim 1, further comprising a gauge that is configured to sense deformation of the conformable portion.

8. A head-mounted device, comprising:
a device housing; and
an optical module that is connected to the device housing, wherein the optical module includes a lens assembly and a conformable portion, wherein the lens assembly is configured to be positioned adjacent to an eye of a user and the conformable portion is engageable with a face portion of the user.

9. The head-mounted device of claim 8, wherein the device housing includes a face seal and the optical module is spaced from the face seal.

10. The head-mounted device of claim 8, wherein the device housing includes an eye chamber and at least part of the optical module is located in the eye chamber.

11. The head-mounted device of claim 8, wherein the device housing includes an intermediate wall that is surrounded by a face seal and the optical module extends outward from the face seal.

12. The head-mounted device of claim 8, wherein the conformable portion is formed from a resilient flexible material.

13. The head-mounted device of claim 8, wherein the conformable portion is formed from a foam rubber material.

14. The head-mounted device of claim 8, wherein the conformable portion is formed from a silicone rubber material.

15. The head-mounted device of claim 8, further comprising an actuator that is operable to move the conformable portion.

16. The head-mounted device of claim 8, further comprising a gauge that is configured to sense deformation of the conformable portion.

17. The head-mounted device of claim 8, wherein the conformable portion extends around a portion of an outer periphery of the lens assembly.

18. The head-mounted device of claim 8, wherein the conformable portion extends continuously around an outer periphery of the lens assembly.

19. An optical module, comprising:
an optical module housing that has a first end, a second end, and an interior space that extends from the first end to the second end;
a display that is connected to the first end of the optical module housing;
a lens assembly that is connected to the second end of the optical module; and
a conformable portion at the second end of the optical module housing, wherein the conformable portion includes a cover portion that defines an enclosed interior space and a fluid in the enclosed interior space.

20. The optical module of claim 19, further comprising an actuator to increase and decrease an amount of the fluid in the enclosed interior space.

21. The optical module of claim 19, wherein the fluid is a magnetorheological fluid, further comprising:
an electromagnet that has an inactive state and an active state, wherein the magnetorheological fluid is flowable when the electromagnet is in the inactive state and is not flowable when the electromagnet is in the active state.

22. The optical module of claim 19, wherein the conformable portion extends around a portion of an outer periphery of the lens assembly.

23. The optical module of claim 19, wherein the conformable portion extends continuously around an outer periphery of the lens assembly.

24. The optical module of claim 19, wherein the conformable portion extends around a portion of an outer periphery of the lens assembly.

25. The optical module of claim 19, wherein the conformable portion extends continuously around an outer periphery of the lens assembly.
